(19) United States
(12) Patent Application Publication
(10) Pub. No.: US 2013/0054292 A1
(43) Pub. Date: Feb. 28, 2013

(54) DETERMINING RELATIVE CRITICALITY OF SERVICE TICKETS IN FACTORY-STYLE SHARED DELIVERY

(71) Applicants: Hari Shankar Gupta, Jaipur (IN); Bikram Sengupta, Bangalore (IN)

(72) Inventors: Hari Shankar Gupta, Jaipur (IN); Bikram Sengupta, Bangalore (IN)

(73) Assignee: INTERNATIONAL BUSINESS MACHINES CORPORATION, Armonk, NY (US)

(21) Appl. No.: 13/217,527

(22) Filed: Aug. 25, 2011

(51) Int. Cl. G06Q 10/06

(52) U.S. Cl. 705/7.15

(57) ABSTRACT

Described herein are methods, systems, apparatuses and products for determining relative criticality of service tickets in factory-style shared delivery. An aspect provides for accessing ticket information, accessing service level agreement information, accessing future volume estimation information, estimating a number of missed service level objectives that are permissible without having a service level agreement breach; and determining a criticality of at least one received ticket based on said ticket information, said service level agreement information, and said future volume estimation information. Other embodiments are disclosed.

### FIELD OF THE INVENTION

The subject matter presented herein generally relates to ticket handling in shared information technology service delivery environments.

### BACKGROUND

An existing mode of delivery of information technology (IT) services has been through a dedicated team of agents for every customer. This approach provides clear accountability, more stability and easier governance. However, such a dedicated model leads to a number of challenges for the vendor, most notably, poor/uneven utilization and difficulties in knowledge sharing. Many vendors have now adopted a so-called “factory-style” model of shared delivery of IT services.

In such a model, a pooling of agents by specialization areas is made, and each pool may serve multiple customers that need services in the particular specialization area. This leads to a significant shift in the role of the vendor vis-à-vis the customer, which creates complexities in scheduling service requests, including ticket handling decisions.

### BRIEF SUMMARY

One aspect provides a method for determining relative criticality of at least one ticket in a shared service delivery environment, comprising: accessing ticket information stored in a computer storage device; accessing service level agreement information stored in a computer storage device; accessing future volume estimation information stored in a computer storage device; and using at least one processor to: estimate a number of missed service level objectives that are permissible without having a service level agreement breach; and determine a criticality of at least one received ticket based on said ticket information, said service level agreement information, and said future volume estimation information.

Another aspect provides a computer program product for determining relative criticality of at least one ticket in a shared service delivery environment, comprising: a computer readable storage medium having computer readable program code embodied therewith, the computer readable program code comprising: computer readable program code configured to access ticket information; computer readable program code configured to access service level agreement information; computer readable program code configured to access future volume estimation information; computer readable program code configured to estimate a number of missed service level objectives that are permissible without having a service level agreement breach; and computer readable program code configured to determine a criticality of at least one received ticket based on said ticket information, said service level agreement information, and said future volume estimation information.

A further aspect provides a system for determining relative criticality of at least one ticket in a shared service delivery environment, comprising: at least one processor; and a memory device operatively connected to the at least one processor; wherein, responsive to execution of program instructions accessible to the at least one processor, the at least one processor is configured to: access ticket information; access service level agreement information; access future volume estimation information; estimate a number of missed service level objectives that are permissible without having a service level agreement breach; and determine a criticality of at least one received ticket based on said ticket information, said service level agreement information, and said future volume estimation information.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example system for determining ticket criticality.

FIG. 2 illustrates an example method for determining ticket criticality.

FIG. 3 illustrates an example method for determining ticket criticality.

FIG. 4 illustrates an example computer system.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the claims, but is merely representative of those embodiments.

Reference throughout this specification to “embodiment(s)” (or the like) means that a particular feature, structure, or characteristic described in connection with the embodiment is included in at least one embodiment. Thus, appearances of the phrases “according to embodiments” or “an embodiment” (or the like) in various places throughout this specification are not necessarily all referring to the same embodiment.

Furthermore, the described features, structures, or characteristics may be combined in any suitable manner in different embodiments. In the following description, numerous specific details are provided to give a thorough understanding of example embodiments. One skilled in the relevant art will recognize, however, that aspects can be practiced without certain specific details, or with other methods, components, materials, et cetera. In other instances, well-known structures, materials, or operations are not shown or described in detail to avoid obfuscation.

In a dedicated team environment, where a team services a particular customer, agents within a team have a synergy of purpose, and would typically work on the most high priority tickets at any time, usually in consultation with the customer. The customer thus has a level of visibility into its dedicated team, and some control on the order in which work gets executed. However, in shared delivery environments, customers have less visibility and/or control over how and/or when their tickets are addressed, as there is no dedicated team for a particular customer, and ownership/control now is shifted to the vendor.

In a shared IT service environment, tickets from different customers, in particular having different service level agreements (SLAs), compete for the attention of the same group of agents. This introduces a natural conflict into the shared system. It can become unclear if the vendor should first take up ticket T of priority P from customer C, or first take up ticket T′ of priority P′ from customer C′. If at least one of the tickets is guaranteed to breach a service level objective (SLO), then it may be wiser to handle those tickets first (and thereby avoid their SLO breaches) which have more impact (in terms of penalty) and/or the possibility of breaching corresponding SLA in the future. Thus, it is apparent that how intelligently these decisions are made by the vendor will influence the financial returns of the vendor, as well as impact the satisfaction of individual customers in the shared environment. Ad-hoc decisions can hasten SLA breach for specific customers, and vendors may have to pay a steep penalty for such decisions.

Accordingly, an embodiment provides for determining the relative criticality of tickets in a shared environment. Such a determination assists vendors in making intelligent decisions regarding ticket handling, and thus promotes the most efficient ticket handling in a shared environment form a viewpoint of potential penalties encountered by missed/late ticket handling.

An embodiment provides a way to determine relative criticality of tickets in shared delivery based on which scheduling decisions may be taken. Criticality is defined herein to mean impact on a SLA. Thus, an important concern is the SLA with each customer. SLAs are for a (customer, priority) combination. For example, “90% of priority 1 tickets for Customer C have to be resolved in 4 hours, else the vendor has to pay a penalty of $D”. The percent value, resolution time, and penalty will vary from one customer (and priority) to another. A SLO is a SLA applied to each ticket. For example, a SLO may be to resolve a priority 1 ticket from a customer X within 4 hours.

Given this, it may be posited that a criticality of a ticket T of priority P from customer C should depend on how close is a SLA breach, which in turn depends on the past performance. Past performance may be determined from historical information, such as how many tickets of priority P have been received so far from customer C, and how many tickets have breached a SLO. A future forecast may also be utilized, such as how many tickets of priority P are expected to be received from customer C in the rest of the SLA window. What penalty is to be paid for a SLA breach on priority P tickets from customer C informs the decision regarding criticality. Thus, the closer to a SLA breach for priority P tickets from customer C, and the higher is the penalty for a breach, the greater is the criticality of a new priority P ticket from customer C. Embodiments are thus configured to determine criticality of tickets given such known parameters, and provide this criticality as a metric to inform vendor(s) which tickets are most critical and should be given highest priority.

The description now turns to the figures. The illustrated example embodiments will be best understood by reference to the figures. The following description is intended only by way of example and simply illustrates certain example embodiments representative of the invention, as claimed.

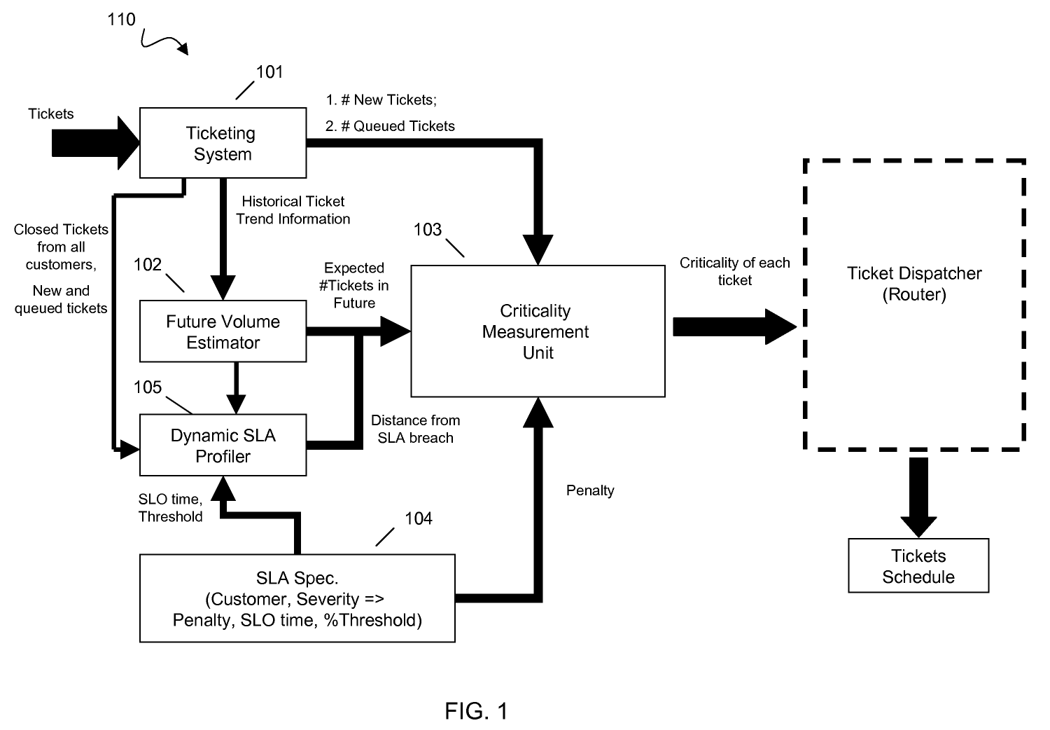

Illustrated in FIG. 1 is an example system for determining criticality of tickets in shared IT service environment. Tickets, such as service problem tickets, are received by the system. The ticketing system 101 queues the tickets as they are received and provides information regarding which tickets are received, from which customer, and information regarding the priority of the tickets to a future volume estimator 102. Tickets are also passed to a criticality measurement unit 103.

SLA specifications for the various customers sharing services in the environment are available from a SLA database repository 104. These SLA specifications are provided to a dynamic SLA profiler 105 that is configured to parse the SLA specifications for the various customers in order to associate SLA information with the tickets received. For example, dynamic SLA profiler obtains information such as SLO time and threshold(s), which allows for determining which tickets from a customer are of which priority, and which may impact an SLO and thus an SLA with that customer.

The ticking system 101 and future volume estimator 102 likewise provide ticketing information to dynamic SLA profiler such that it may appropriately evaluate each customer's status regarding missed SLOs, and provide a distance from a SLA breach for a customer. The output of the future volume estimator 102, namely an expected number of tickets in the future (for a given service window, however appropriately defined given the shared environment), the output of the ticketing system 101, namely the new tickets and the queued tickets, and the output of the dynamic SLA profiler 105, namely distance from SLA breach, are provided to the criticality measurement unit 103 such that it may provide a criticality measure or metric for each ticket received. The criticality measure is provided to a ticket dispatcher, which may be an automatic router or a system analyst, to appropriately schedule the tickets given the criticality thereof.

An embodiment utilizes the criticality measurement unit to provide, utilizing the information regarding tickets received, future forecasts, SLOs and SLAs, a uniform index of relative criticality, given currently available information. Thus, a point-in-time statement of comprehensive criticality in a given SLA window is available for ticket scheduling in a shared environment. The criticality measurement thus may be utilized as input for determining the optimal scheduling of tickets.

As an example, the criticality of a given ticket may be computed as follows. For a ticket of customer “i” with priority “j”, criticality of the ticket, Cᵢⱼ, is:

$${C}_{ij} = \{ \begin{matrix}( {X}_{ij} + {Y}_{ij}^{′} ) * {P}_{ij} / ( {Z}_{ij} + 1 ) , & if {Z}_{ij} < {X}_{ij} + {Y}_{ij}^{′} \\ 0 , & otherwise\end{matrix}$$

where the estimated number of (maximum) tickets allowed to breach SLO among present and future tickets without breaching the SLA is Zᵢⱼ, and may be computed as:

Zᵢⱼ=((Xᵢⱼ+Yᵢⱼ+Y′ᵢⱼ)*Rᵢⱼ/100)−Uᵢⱼ

where Rᵢⱼ is the percentage of tickets allowed to breach for a given SLA, Pᵢⱼ is the penalty of a SLO breach beyond the SLA, Yᵢⱼ is the number of tickets closed in the past, Y′ᵢⱼ is the number of tickets to be scheduled (now), Xᵢⱼ is the number of tickets expected to come in the future (future estimate), and Uᵢⱼ is the number of tickets that have breached an SLO in the past (among the closed tickets). Thus, if the maximum number of tickets that can be allowed to breach SLO without breaching SLA, that is Zᵢⱼ is less than the number of tickets to be scheduled now plus the number of expected tickets, criticality may be measured by summing the current tickets Y′ᵢⱼ and the expected tickets Xᵢⱼ, multiplied by the appropriate penalty Pᵢⱼ, given an SLA, and dividing this value by the estimated permissible number of tickets missed plus 1 (Zᵢⱼ+1).

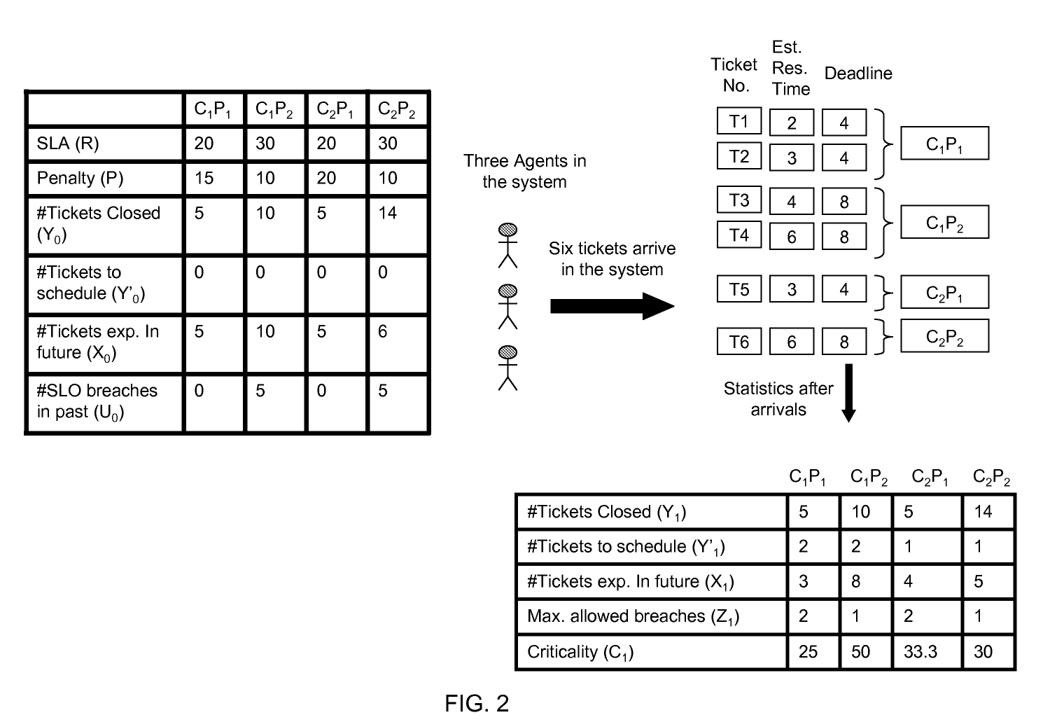

As an example, referring to FIG. 2, the usability of the proposed ticket criticality measure is illustrated. In the example, a scenario in which there are four different types of tickets in a shared service delivery system based on the customers to whom the tickets belong, and priorities of the tickets, is illustrated. Namely, C₁P₁ represent customer-1 and priority-1, C₁P₂ for customer-1 and priority-2, C₂P₁ for customer-2 and priority-1, and C₂P₂ for customer-2 and priority-2. In the first table to the left of FIG. 2, the rows represent the following parameters for each of different types of tickets:
SLA (R): Service level agreement for the ticket type in percentage (how many tickets at maximum of any particular type are allowed to breach SLO without penalty)
Penalty (P): Penalty for a ticket breaching SLO beyond the SLA percentage for each ticket type
#Tickets
Closed (Y₀): Number of tickets closed so far of any particular ticket type
#Tickets to
Schedule (Y′₀): Number of tickets to be scheduled now for each ticket type
#Tickets expected
In future (Y₀): Expected number of tickets of each type
#SLO breaches
in past (U₀): Number of tickets which have breached SLO in the past of each type

The above parameters may be used to compute the criticality of each ticket, at any point of time. It should be noted that the criticality is for each ticket type and not for each individual ticket, that is, if two tickets are of same type and have to be scheduled at the same time, then the criticality of both the tickets would be the same. A criticality measure may be used to compute the relative criticality (or equivalently relative importance) of different ticket types.

In the example of FIG. 2, it is assumed that there are three agents in the system, and in the next step six tickets arrive in the system to schedule, as show in the second table to the right of FIG. 2. The following table near the bottom of FIG. 2 gives the statistics after these six arrivals, and based on these values the criticality of each of these six tickets (T1-T6) may be computed.

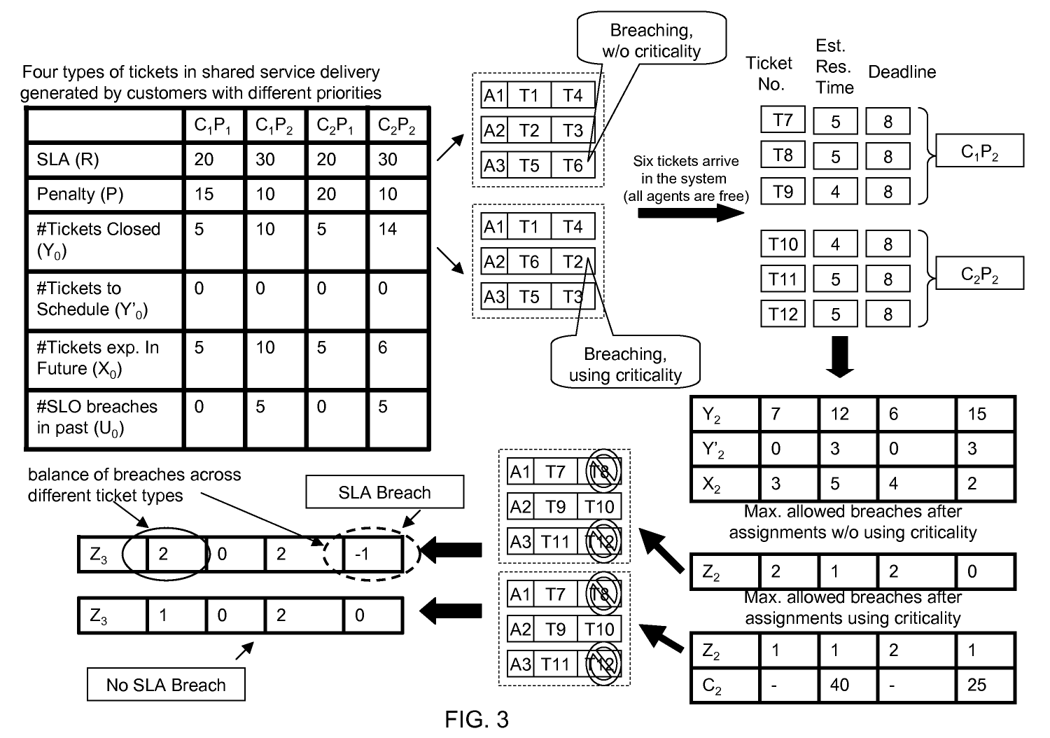

Referring to FIG. 3, the first table to the left of FIG. 3 repeats all the statistics after these six arrivals (T1-T6), and the last row in the table shows the criticality of each of the ticket type. Next these tickets are scheduled with and without using a criticality measure to compare the results of both. As illustrated, for any given schedule of these six tickets, at least one SLO breach occurs. Therefore, in the simple scheduling (without using criticality) importance is given to the tickets which are of higher priority (that is, have higher penalties for breaching SLO) and assign tickets T1, T2, and T5 first to the agents A1, A2, and A3 respectively, and then the rest of 3 tickets. As a consequence the ticket T6 happens to breach the SLO.

In the schedule using criticality, if some tickets out of all the given tickets lead to breach, then an embodiment allows the tickets of lower criticality value to breach instead of the tickets that are of higher criticality values. Since the tickets (T1 and T2) of type C₁P₁ turn out to be least critical, with criticality value (=25), and since at least one ticket will certainly breach SLO for any given schedule, therefore an embodiment allows T2 to breach due to its low criticality value (T1 may also be allowed to breach in place of T2 breach).

In the next cycle, six more tickets (T7-T12 of types C₁P₂ and C₂P₂) arrive in the system, and the statistics after arrival are given the following table to the right in FIG. 3. As for any given schedule of these new arrivals at least two tickets are destined to breach the SLO, and since in the simple scheduling the number of tickets at maximum allowed to breach SLO for lower priorities are 1 and 0, respectively, at least one of the breaches gets penalized. Whereas, in the scheduling using criticality, as the lower priority ticket types turned out to be more critical earlier, therefore there is a breach of SLO for one ticket of each of the two ticket types, the system finally incurs no penalty by scheduling the tickets in a way such that only one ticket of each of the two types breaches SLO.

Accordingly, by applying criticality the system may balance breaches across ticket types, allowing the system to more flexibly avoid a violation by handling tickets out of order. Using such an approach, a vendor will be permitted to more flexibly handle incoming tickets by allowing only non-critical (or lower-critical) tickets to breach (not be handled in time, missed). This provides a more balance system from the point of view of managing customer expectations for ticket handling with regard to avoiding violations.

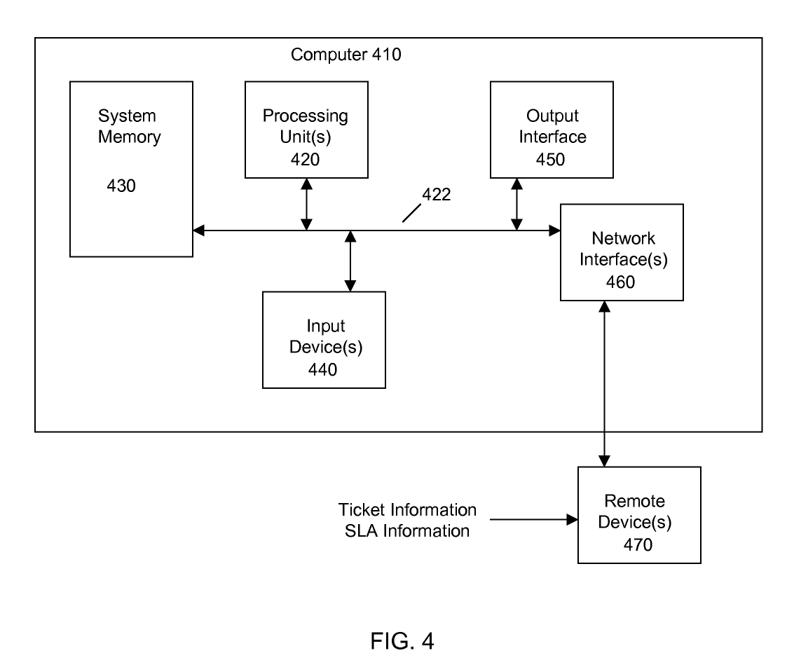

Referring to FIG. 4, it will be readily understood that embodiments may be implemented using any of a wide variety of devices or combinations of devices. An example device that may be used in implementing embodiments includes a computing device in the form of a computer 410. In this regard, the computer 410 may execute program instructions configured to provide for determining relative criticality of service tickets in factory-style shared delivery, and perform other functionality of the embodiments, as described herein.

Components of computer 410 may include, but are not limited to, at least one processing unit 420, a system memory 430, and a system bus 422 that couples various system components including the system memory 430 to the processing unit(s) 420. The computer 410 may include or have access to a variety of computer readable media. The system memory 430 may include computer readable storage media in the form of volatile and/or nonvolatile memory such as read only memory (ROM) and/or random access memory (RAM). By way of example, and not limitation, system memory 430 may also include an operating system, application programs, other program modules, and program data.

A user can interface with (for example, enter commands and information) the computer 410 through input devices 440. A monitor or other type of device can also be connected to the system bus 422 via an interface, such as an output interface 450. In addition to a monitor, computers may also include other peripheral output devices. The computer 410 may operate in a networked or distributed environment using logical connections (network interface 460) to other remote computers or databases (remote device(s) 470). The logical connections may include a network, such local area network (LAN) or a wide area network (WAN), but may also include other networks/buses.

As will be appreciated by one skilled in the art, aspects may be embodied as a system, method or computer program product. Accordingly, aspects of the present invention may take the form of an entirely hardware embodiment, an entirely software embodiment (including firmware, resident software, micro-code, et cetera) or an embodiment combining software and hardware aspects that may all generally be referred to herein as a “circuit,” “module” or “system.” Furthermore, aspects of the present invention may take the form of a computer program product embodied in at least one computer readable medium(s) having computer readable program code embodied thereon.

Any combination of at least one computer readable medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having at least one wire, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible or non-signal medium that can contain or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments may be written in any combination of at least one programming language, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments are described with reference to figures of methods, apparatus (systems) and computer program products according to embodiments. It will be understood that portions of the figures can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Although illustrated example embodiments have been described herein with reference to the accompanying drawings, it is to be understood that embodiments are not limited to those precise example embodiments, and that various other changes and modifications may be affected therein by one skilled in the art without departing from the scope or spirit of the disclosure.

1-10. (canceled)

11. A computer program product for determining relative criticality of at least one ticket in a shared service delivery environment, comprising:
a computer readable storage medium having computer readable program code embodied therewith, the computer readable program code comprising:
computer readable program code configured to access ticket information;
computer readable program code configured to access service level agreement information;
computer readable program code configured to access future volume estimation information;
computer readable program code configured to estimate a number of missed service level objectives that are permissible without having a service level agreement breach; and
computer readable program code configured to determine a criticality of at least one received ticket based on said ticket information, said service level agreement information, and said future volume estimation information.

12. The computer program product of claim 11, wherein said service level agreement information specifies, for a customer-priority pair, a service level objective, an expected percentage of service level objective adherence, and a service level agreement breach penalty.

13. The computer program product of claim 11, wherein said future volume estimation information provides, for a customer-priority pair, ticket trend history information, and an estimation of a number of tickets expected to arrive during a service window.

14. The computer program product of claim 11, wherein to estimate a number of missed service level objectives that are permissible without having a service level agreement breach further comprises:
providing a determination of a number of service level objective breaches that have already occurred for a customer-priority pair; and
providing a determination of a number of tickets to be handled for a customer-priority pair, including existing, queued tickets and estimated, future tickets.

15. The computer program product of claim 11, wherein to determine a criticality of at least one received ticket further comprises:
determining a criticality of each ticket for a customer-priority pair to be scheduled at a given point in time by considering a distance from a service level agreement breach, a penalty paid for a service level agreement breach, and a total number of tickets for the customer-priority pair to be scheduled during a service window.

16. The computer program product of claim 15, wherein responsive to a determination that, for a given ticket, the distance from a service level agreement breach is less than a threshold, the criticality of the given ticket is increased.

17. The computer program product of claim 16, wherein, responsive to a determination that, for the given ticket, the penalty paid for a service level agreement breach is greater than a threshold, the criticality of the given ticket is increased.

18. The computer program product of claim 17, wherein, responsive to a determination that, for the given ticket, the total number of tickets for the customer priority pair is greater than a threshold, the criticality of the given ticket is increased.

19. The computer program product of claim 11, further comprising computer readable program code configured to provide a criticality measurement responsive to determining a criticality of at least one received ticket.

20. A system for determining relative criticality of at least one ticket in a shared service delivery environment, comprising:
at least one processor; and
a memory device operatively connected to the at least one processor;
wherein, responsive to execution of program instructions accessible to the at least one processor, the at least one processor is configured to:
access ticket information;
access service level agreement information;
access future volume estimation information;
estimate a number of missed service level objectives that are permissible without having a service level agreement breach; and
determine a criticality of at least one received ticket based on said ticket information, said service level agreement information, and said future volume estimation information.
